(19) United States
(12) Patent Application Publication
(10) Pub. No.: US 2015/0059860 A1
(43) Pub. Date: Mar. 5, 2015

(54) METHOD TO STABILIZE PRESSURE IN AN ELECTRO-HYDRAULICALLY CONTROLLED BRAKE CHARGE SYSTEM

(71) Applicant: Caterpillar SARL, Geneva (CH)

(72) Inventors: Brian D. Horton, Austin, TX (US); Steven E. Johnson, Crest Hill, IL (US)

(73) Assignee: Caterpillar SARL, Geneva (CH)

(21) Appl. No.: 14/536,714

(22) Filed: Nov. 10, 2014

(51) Int. Cl. B60T 17/22

(52) U.S. Cl. CPC B60T 17/222
USPC 137/14

(57) ABSTRACT

A method to stabilize pressure in an electro-hydraulically controlled brake charge system is provided. The brake charge system includes a load-sensing pump, an accumulator, a sensor, a high pressure cut-off valve, a controller, and a charge supply valve. The method includes determination of a pre-determined cut-out pressure and a pre-determined time threshold. The accumulator is pressurized with the fluid from the load-sensing pump. As accumulator pressure becomes equal to the pre-determined cut-out pressure, the controller initiates a counter-timer. When the counter-timer reaches the pre-determined time threshold, an electronic solenoid is activated, flow of the fluid is thus controlled through the charge supply valve based on a signal from the electronic solenoid.

### TECHNICAL FIELD

The present disclosure generally relates to a brake charge system. More particularly, the present disclosure relates to a method to stabilize pressure in an electro-hydraulically controlled brake charge system.

### BACKGROUND

Earthmoving and construction work machines often employ hydraulic systems that provide functionality and control to various aspects of the machines. For example, some work machines employ hydraulic brake systems to control driving speeds and fan hydraulic drive systems that control machine cooling. As each system may have separate flow requirements, the hydraulic systems on some work machines are isolated systems, each with a separate fluid pump. Even in a combined system, each hydraulic system may require independent fluid-flow parameters and requirements. To address this, some known systems direct fluid from a common pump to one system or the other system by use of a cut-in/cut-out device. The cut-in/cut-out device may be an electro-hydraulic pump unit with on/off control via set-point.

Conventionally, the work machine has a hydraulic system for a brake system. Moreover, the hydraulic system may be adapted to drive other integrated hydraulic systems, such as a cooling system. The hydraulic system may include one or more accumulators, a pump, a charge supply valve, and a fluid reservoir. When a charge cycle is initiated, the fluid is directed from the reservoir to the brake system to charge or fill the one or more accumulators with fluid. When a charge cycle is initiated, the accumulator is said to be in a charging state. Upon completion of the charge cycle, as the accumulator reaches a pre-determined accumulator pressure, the pump having the cut-in/cut-out capability may cut-out or shut-off fluid flow to the brake system. At this point, the brake charge system is said to be in a non-charging state. In addition, the cut-in/cut-out device may direct fluid to the cooling system instead of the brake system. Through normal braking, the fluid in the accumulator may be gradually expended until the accumulator pressure falls below a pre-determined threshold pressure. When this occurs, the cut-in/cut-out device may direct fluid flow to the brake system and the brake charge system will again be in a charging state. When this occurs, the fluid flow to the cooling system is reduced as needed, potentially to zero. Due to the alternate occurrence of cut-in and cut-out of the fluid to the one or more accumulators, the pressure in the brake system fluctuates between a relatively high level and a relatively low level. The brake system may commonly experience pressure spikes and instability. Instability may occur at the end of the charge cycle, which is, at cut-out of fluid flow to the brake system. Instability may be caused by the step change in the fluid flow when the system transitions between the charging state and the non-charging state. Such instabilities may cause component failure due to overpressure and/or pressure acceleration. Also, instabilities may cause audible noise that is irritating to personnel. Further, instabilities in the brake system may be transmitted into other systems that may cause related failures and issues.

U.S. Publication No. 2006/181143 discloses an electronically-controlled hydraulic brake system where hydraulic pressure in a wheel cylinder of a brake is controlled by an electric control unit. The brake system is controlled based on an instruction from a brake electronic control unit (ECU) as a hydraulic pressure controller. However, instabilities in the hydraulic brake system may occur and may not be addressed by this reference.

The brake charge system disclosed and described herein may overcome one or more of the problems in the existing systems.

### SUMMARY OF THE INVENTION

The present disclosure is related to a method to stabilize pressure in an electro-hydraulically controlled brake charge system.

In accordance with the present disclosure, the brake charge system includes a load-sensing pump, an accumulator, a sensor for sensing accumulator pressure, a high pressure cut-off valve, a controller, and a charge supply valve. The method includes pressurization of the accumulator, with the fluid from the load sensing pump. The accumulator pressure, measured by the sensor, is compared with a pre-determined cut-out pressure. When the accumulator pressure, measured by the sensor, exceeds the pre-determined cut-out pressure, a counter-timer is initiated. The counter-timer is continuously compared with a pre-determined time threshold. When the counter-timer becomes equal to the pre-determined time threshold, that is, the pre-determined time threshold has elapsed, a flow of the fluid into the accumulator is minimized.

### BRIEF DESCRIPTION OF THE DRAWINGS

FIG. 1 is a profile view of a machine (in broken line format) adapted with a brake system (in solid line format), in accordance with the concepts of the present disclosure;

FIG. 2 is a schematic and diagrammatic illustration of a hydraulic schematic showing a brake charge system of the machine of FIG. 1, in accordance with the concepts of the present disclosure; and

FIG. 3 illustrates a flowchart of a disclosed method to stabilize pressure in the electro-hydraulically controlled brake charge system of FIG. 2, in accordance with the concepts of the present disclosure.

### DETAILED DESCRIPTION

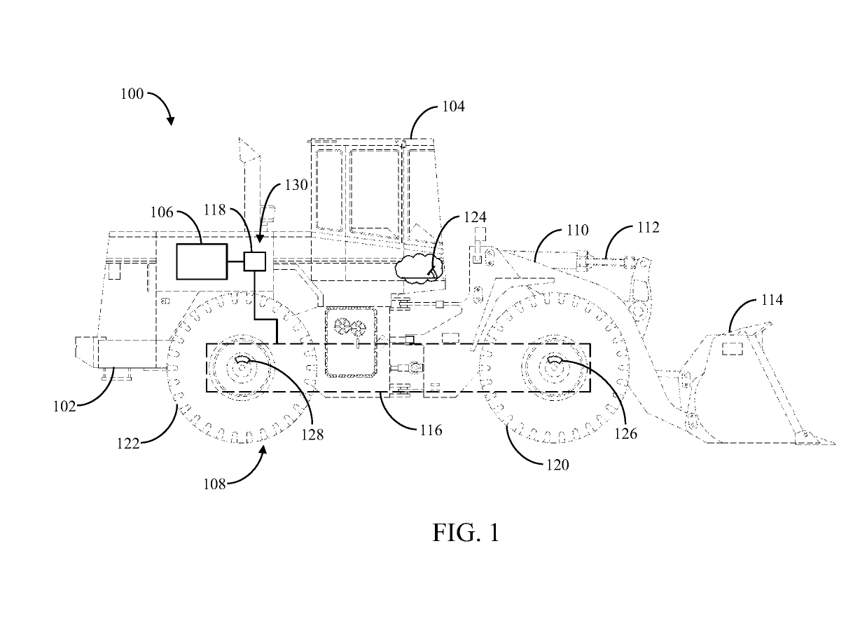

Referring to FIG. 1, there is shown an exemplary machine 100. The machine 100 may be a mobile vehicle that performs some type of operation associated with an industry, such as mining, construction, farming, transportation, or any other industry known in the art. For example, the machine 100 may be a wheel loader (as depicted in FIG. 1), a motor grader, a backhoe, an excavator, a scraper, an off-highway truck, a passenger vehicle, or any other vehicle or machine known in the art. In the illustrated embodiment, the machine 100 includes a frame 102, an operator station 104, a power source 106, a drive system 108, a lift arm 110, a lift cylinder (not shown), a tilt cylinder 112, a work tool 114, a brake system 116, and a controller 118.

The frame 102 may include any structural member or assembly of members that support movement of the machine 100. The frame 102 may support the operator station 104, which may contain controls necessary to operate the machine 100. Controls that may operate the machine 100 may include input devices (not shown) for propelling the machine 100 and other machine components. The input devices (not shown) may be adapted to receive input from the operator indicative of a desired work tool 114 or machine movement. The input devices (not shown) may include a steering wheel, single or multi-axis joysticks, switches, knobs, or other known devices that are located proximal to an operator seat. The input devices (not shown) may be configured to generate control signals indicative of a desired position, force, velocity, and/or acceleration of the lift cylinder (not shown) and the tilt cylinder 112. The lift cylinder (not shown) and the tilt cylinder 112 may be operably coupled to the lift arm 110. The lift cylinder (not shown) and the tilt cylinder 112 are connected to the frame 102 at one end and coupled to the work tool 114 at as a second end. Expansion of the lift cylinder (not shown) may result in elevation of the lift arm 110. Retraction of the lift cylinder (not shown) results in lowering of the lift arm 110.

The frame 102 may support the power source 106. The power source 106 may be an engine, such as a diesel engine, a gasoline engine, a gaseous fuel-powered engine, a natural gas engine, or other engine known to one skilled in the art. It is contemplated that the power source 106 may alternatively embody a non-combustion source of power, such as a fuel cell, a power storage device, or another suitable source of power. The power source 106 may produce a mechanical or electrical power output that may be converted to hydraulic power. The power source 106 may power the drive system 108 that may include a pair of front wheels 120 and a pair of rear wheels 122, adapted to support the machine 100. The front wheels 120 and the rear wheels 122 may be adapted to steer and maneuver the machine 100 and to propel the machine 100 in forward and reverse directions.

The machine 100 further includes the brake system 116, operatively connected to the controller 118. The brake system 116 may be adapted to decelerate the movement of the machine 100, when the machine 100 is in motion. The controller 118 may be operatively connected to the power source 106, the brake system 116, and the operator station 104. The controller 118 may be adapted to receive signals from the input devices (not shown) associated with the operator station 104. The controller 118 may monitor and provide appropriate output signals to various systems to control the movement of the machine 100 and the work tool 114, or to perform various other functions and tasks.

The brake system 116 may be associated with the front wheels 120 and the rear wheels 122. The brake system 116 may further be operable with other input devices, such as a brake pedal 124 within the operator station 104. The brake system 116 may be hydraulically driven. The brake system 116 may include front brakes 126 and rear brakes 128. The front brakes 126 and rear brakes 128 may, respectively, be operatively associated with the front wheels 120 and rear wheels 122. The front brakes 126 and rear brakes 128 may selectively decelerate movement of the machine 100. In an embodiment, each of the front brakes 126 and the rear brakes 128 may include a hydraulic pressure-actuated wheel brake, such as a disk brake or a drum brake. The front brakes 126 and the rear brakes 128 are disposed intermediate to the front wheels 120, the rear wheels 122, and a final drive assembly (not shown) of the machine 100. When actuated, pressurized fluid within the front brakes 126 and the rear brakes 128 may increase the rolling friction of the machine 100, which retards the movement of the machine 100. The front brakes 126 and the rear brakes 128 may be operated in a known manner, such as by the brake pedal 124 disposed within the operator station 104 of the machine 100. The brake pedal 124 may be associated with the front brakes 126 and the rear brakes 128, for manual control of the front brakes 126 and the rear brakes 128. As an operator depresses the brake pedal 124 along a braking range, pressurized fluid may be directed to the front brakes 126 and the rear brakes 128. The degree of the brake pedal 124 depression proportionally controls the pressure of the fluid that is supplied to the front brakes 126 and the rear brakes 128.

The brake system 116 may further include a brake charge system 130 associated with at least one of the front brakes 126 or the rear brakes 128. The brake charge system 130 may include a plurality of fluid components and electrical components. The brake charge system 130 may be operatively connected to control the braking capacity of the brake system 116. Hence, the brake charge system 130 controls the braking capacity of the machine 100. In the illustrated embodiment, the brake charge system 130 is operatively connected to the controller 118 to regulate the flow of pressurized fluid directed to the front brakes 126 and rear brakes 128. In an embodiment, the brake charge system 130 may be adapted to drive other integrated hydraulic systems, such as a cooling system, which may operate from a common fluid source. The fluid components and electrical components may cooperate to control the braking and other capacities of the machine 100.

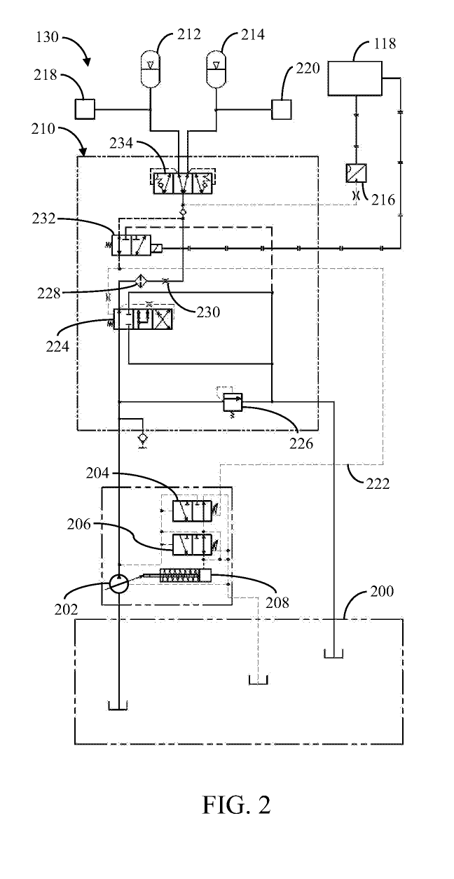

Referring to FIG. 2, there is shown a schematic of the brake charge system 130. The brake charge system 130 may include a tank 200, a load-sensing pump 202, a margin valve 204, a high pressure cut-off valve 206, a cylinder 208, a charge supply valve 210, the controller 118, a first accumulator 212, a second accumulator 214, a sensor 216, a first brake control valve 218, and a second brake control valve 220.

The brake charge system 130 is adapted to draw fluid from and return fluid to the tank 200. The tank 200 may be adapted to hold a supply of fluid. For example, the tank 200 may constitute a low-pressure reservoir adapted to hold the supply of the fluid. The fluid may include dedicated hydraulic oil, engine lubrication oil, transmission lubrication oil, or any other fluid known in the art. One or more hydraulic systems within the machine 100 may draw fluid from and return fluid to the tank 200. The tank 200 is in fluid communication with the load-sensing pump 202. The load-sensing pump 202 is adapted to provide pressurized fluid to the brake charge system 130. The load-sensing pump 202 may be adapted to pressurize fluid drawn from the tank 200 and direct the pressurized fluid to the first accumulator 212 and the second accumulator 214. In the illustrated embodiment, the load-sensing pump 202 embodies a variable displacement piston pump with load-sensing capabilities, which may permit the load-sensing pump 202 to operate or provide fluid flow only when necessary, thus improving the efficiency of the machine 100. In an embodiment, the load-sensing pump 202 may embody a fixed displacement pump adapted to produce a flow of pressurized fluid proportional to a rotational input speed. The load-sensing pump 202 may be directly driven by an electric motor (not shown). The load-sensing pump 202 may or may not be a fixed delivery pump, that is, a pump that delivers a constant flow rate of pressurized fluid per input revolution.

The load-sensing pump 202 is operated by at least one of the margin valve 204 and the high pressure cut-off valve 206. The margin valve 204 is adapted to take an accumulator pressure as reference signal, or load-sense signal, via a load-sense line 222. The margin valve 204 is adapted to add a margin pressure to the accumulator pressure and generate a margin valve output signal for the cylinder 208. Based on the margin valve output signal, which corresponds to the margin valve output pressure, the cylinder 208 actuates a swash plate of the load-sensing pump 202. Accordingly, the load-sensing pump 202 delivers the fluid to the charge supply valve 210 at an output pressure that corresponds to the margin valve output pressure.

The high pressure cut-off valve 206 has a pre-determined cut-off pressure at which the high pressure cut-off valve 206 initiates operation. The pre-determined cut-off pressure of the high pressure cut-off valve 206 is set as a sum of spring biasing pressure and tank pressure. The high pressure cut-off valve 206 is adapted to operate the load-sensing pump 202 when the output pressure corresponds to the margin valve output pressure and exceeds the pre-determined cut-off pressure. The high pressure cut-off valve 206 actuates the cylinder 208 to displace the load-sensing pump 202 to deliver the fluid to the charge supply valve 210 at the output pressure equal to the pre-determined cut-off pressure. During charging one of the first accumulator 212 and the second accumulator 214, via the charge supply valve 210, when the accumulator pressure becomes equal to the pre-determined cut-out pressure, the controller 118 initiates a counter-timer. The counter-timer is initiated for a delay to be implemented (in unit of time) for a cut-out event. When charging of one of the first accumulator 212 and the second accumulator 214, via the charge supply valve 210 is stopped, the condition is referred to as the cut-out event.

The charge supply valve 210 is disposed between the load-sensing pump 202 and each of the first accumulator 212 and the second accumulator 214. The charge supply valve 210 may be adapted to deliver the fluid from the load-sensing pump 202 to the brake charge system 130, such that the fluid pressure of the first accumulator 212 and the second accumulator 214 is maintained between cut-in and cut-out during normal operating conditions. The first accumulator 212 and the second accumulator 214, respectively, are in fluid communication with the first brake control valve 218 and the second brake control valve 220, to control braking during machine operation. The charge supply valve 210 may include a priority valve 224, a relief valve 226, a screen 228, a charge rate limiting orifice 230, an electronic solenoid 232, and an inverse shuttle valve 234. In embodiments including one or more integrated hydraulic systems, the charge supply valve 210 includes the priority valve 224. In such embodiments, the functions of the integrated hydraulic system and the brake system 116 are integrated into one subsystem supplied by the load-sensing pump 202. In some embodiments, the charge supply valve 210 further includes the relief valve 226.

The priority valve 224 is in fluid communication with the load-sensing pump 202. The priority valve 224 may be adapted to provide fluid flow to the first accumulator 212, the second accumulator 214, and to the other hydraulic system. The priority valve 224 ensures that pressure is continuously available to the first accumulator 212 and the second accumulator 214 for brake charging, thus ensuring that charge of the first accumulator 212 and the second accumulator 214 has priority over the other hydraulic system. The fluid may be directed to the first accumulator 212 and the second accumulator 214 regardless of demand at the other hydraulic system. The fluid exiting the priority valve 224 flows through the screen 228 and the charge rate limiting orifice 230. The fluid undergoes a reduction in pressure, when it flows across the charge rate limiting orifice 230.

The charge supply valve 210 includes the electronic solenoid 232, which may be electrically driven to direct the fluid from the priority valve 224 to the inverse shuttle valve 234. The inverse shuttle valve 234 is adapted to proportion the flow of fluid to the first accumulator 212 and the second accumulator 214. The inverse shuttle valve 234 is piloted by the pressure between the first accumulator 212 and the second accumulator 214. For example, if the first accumulator 212 has the higher pressure, the first accumulator 212 will bias the inverse shuttle valve 234 to provide fluid flow to the second accumulator 214 with the lower pressure such that the first accumulator 212 and the second accumulator 214 are pressurized or charged evenly.

The sensor 216 may be associated with the first accumulator 212 and the second accumulator 214. The sensor 216 may be adapted to sense and to communicate signals indicative of the pressure within or between the first accumulator 212 and the second accumulator 214. The pressure of the first accumulator 212 and the second accumulator 214 may be controlled within a range of pressures. In an embodiment, a lower threshold defines a pre-determined cut-in pressure and an upper threshold defines a pre-determined cut-out pressure. The first accumulator 212 and the second accumulator 214 are charged via the margin valve 204, at the margin valve output pressure, in order to achieve the cut-out pressure level. In the illustrated embodiment, the controller 118 may communicate with the sensor 216 to determine the pressure by use of a pressure-sensor arbitration. The first accumulator 212 and the second accumulator 214 may be adapted to hold a supply of pressurized fluid at a desired pressure and to provide the desired fluid to slow, decelerate, or stop movement of the machine 100. For example, the first accumulator 212 and the second accumulator 214 may be maintained above a predetermined threshold to provide brake pressure when desired by the operator. In other words, the first accumulator 212 and the second accumulator 214 are adapted to store fluid pressure for brake control. In addition, the relief valve 226 may protect the first accumulator 212 and the second accumulator 214 from being over-charged or over-pressurized.

Further, the brake system 116 includes the controller 118, which is operably coupled to the electronic solenoid 232 and the sensor 216. The controller 118 evaluates signals from the sensor 216. Further, the controller 118 uses the signals to generate control signals for electrical actuation of the charge supply valve 210, via the electronic solenoid 232, to maintain desired pressure in the first accumulator 212 and the second accumulator 214. The controller 118 monitors the accumulator pressure in the first accumulator 212 and the second accumulator 214, to determine if the accumulator pressure is equal to the pre-determined cut-out pressure. The controller 118 initiates the counter-timer to delay the cut-out event, on determination that the accumulator pressure is equal to the pre-determined cut-out pressure. On initiation of the counter-timer, the controller 118 compares the counter-timer with a pre-determined time threshold, which is determined by the controller 118 and is required to delay the cut-out event. The controller 118 may monitor the overall pressure of the brake system 116 and report the brake status to the operator and other systems. By control of the charge supply valve 210, the controller 118 controls the input fluid flow to the first accumulator 212 and the second accumulator 214.

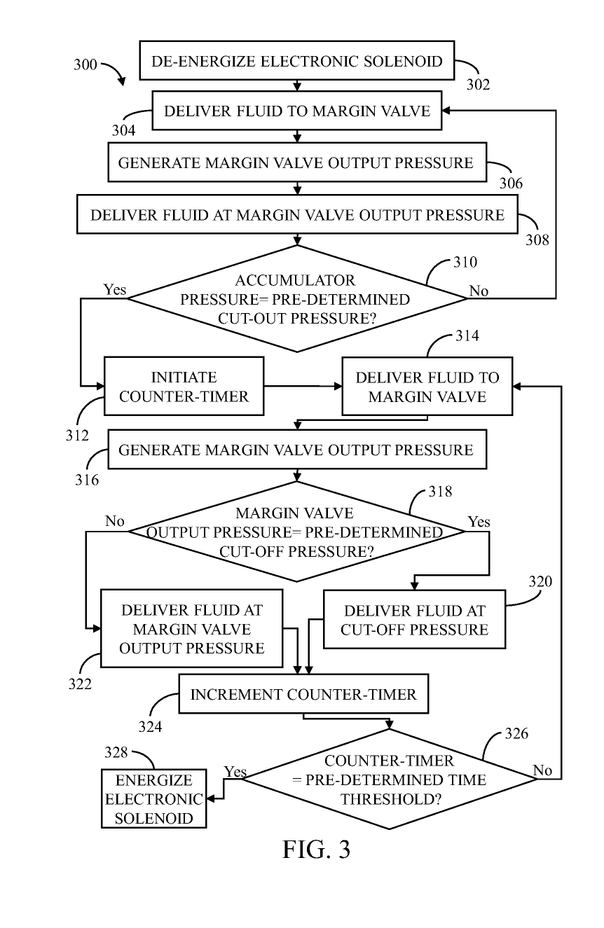

Referring to FIG. 3, there is shown a flowchart depicting a method 300 to stabilize pressure in the brake charge system 130. The method 300 is explained in conjunction with elements from FIG. 1 and FIG. 2. The method 300 starts with step 302.

At step 302, the controller 118 sends signals to de-energize the electronic solenoid 232 to initiate a charge cycle for the first accumulator 212 and the second accumulator 214. An event when the controller 118 de-energizes the electronic solenoid 232 may be referred to as cut-in event. The method 300 proceeds to step 304.

At step 304, a pilot fluid is supplied to the margin valve 204. The pilot fluid is at an accumulator pressure that is within or between the first accumulator 212 and the second accumulator 214. The accumulator pressure acts as a reference signal for the margin valve 204. The method 300 proceeds to step 306.

At step 306, the margin valve 204 senses the accumulator pressure or the reference signal and generates an output signal for the cylinder 208. The output signal corresponds to a margin valve output pressure, which is sum of the accumulator pressure and margin pressure created by the margin valve 204. The method 300 proceeds to step 308.

At step 308, the cylinder 208 actuates the load-sensing pump 202. The load-sensing pump 202 delivers fluid to at least one of the first accumulator 212 and the second accumulator 214, at an output pressure, which is equal to the margin valve output pressure. In other words, the margin valve 204 operates the load-sensing pump 202 to deliver the fluid to the charge supply valve 210. The method 300 proceeds to step 310.

At step 310, based on the signal from the sensor 216, the controller 118 determines whether the accumulator pressure is equal to the pre-determined cut-out pressure. If the output pressure is equal to the pre-determined cut-out pressure, then the method 300 proceeds to step 312. If the output pressure is less than the pre-determined cut-out pressure, then the method 300 returns to step 304.

At step 312, the controller 118 initiates the counter-timer. The method 300 proceeds to step 314.

At step 314, upon actuation of the counter-timer, the pilot fluid is delivered to the margin valve 204. The method 300 proceeds to step 316.

At step 316, the margin valve output pressure is generated by the margin valve 204, based on the reference signal corresponding to the pilot fluid delivered to the margin valve 204. The method 300 proceeds to step 318.

At step 318, the load-sensing pump 202 senses if the margin valve output pressure is equal to the pre-determined cut-off pressure of the high pressure cut-off valve 206. When the load-sensing pump 202 senses that the margin valve output pressure is equal to the pre-determined cut-off pressure, the method 300 proceeds to step 320. When the load-sensing pump 202 senses that the margin valve output pressure is less than the pre-determined cut-off pressure, the method 300 proceeds to step 322.

At step 320, the cylinder 208 actuates the load-sensing pump 202. The load-sensing pump 202 delivers fluid to at least one of the first accumulator 212 and the second accumulator 214, at the output pressure, which is equal to the pre-determined cut-off pressure. The method 300 proceeds to step 324.

At step 322, the cylinder 208 actuates the load-sensing pump 202. The load-sensing pump 202 delivers fluid to at least one of the first accumulator 212 and the second accumulator 214, at the output pressure, which is equal to the margin valve output pressure. The method 300 proceeds to step 324.

At step 324, the counter-timer is incremented towards the pre-determined time threshold. The method 300 proceeds to the step 326.

At step 326, the controller 118 compares the counter-timer with the pre-determined time threshold. If the controller 118 determines that the counter-timer is equal to the pre-determined time threshold, then the method 300 proceeds to end step 328. If the controller 118 determines that the counter-timer is less than or not equal to the pre-determined time threshold, then the method 300 returns to step 314.

At end step 328, the controller 118 sends a signal, to energize the electronic solenoid 232, for the cut-out event. Energization of the electronic solenoid 232 results in the cut-out event, that is, stop of flow of the fluid to the first accumulator 212 and the second accumulator 214. Hence, the charging is stopped. In an embodiment, the electronic solenoid 232 may be energized after the pre-determined time threshold corresponding to the counter-timer, has elapsed.

### INDUSTRIAL APPLICABILITY

In operation, the controller 118 receives pressure signal for at least one of the first accumulator 212 and the second accumulator 214, via the sensor 216. When the pressure in at least one of the first accumulator 212 and the second accumulator 214 is below the lower threshold, the controller 118 de-energizes the electronic solenoid 232 for initiation for the charge cycle. Upon de-energization of the electronic solenoid 232, the pilot fluid at the accumulator pressure is delivered to the margin valve 204, via the load-sense line 222. The margin valve 204 determines the accumulator pressure as the reference signal and delivers the margin valve 204 output to the cylinder 208. The cylinder 208 actuates the load-sensing pump 202 to deliver the fluid to the charge supply valve 210 at the output pressure equal to the margin valve output pressure. The output pressure of the load-sensing pump 202 increases transiently during the charge cycle until the controller 118 determines that the output pressure has reached the pre-determined cut-out pressure. As the output pressure of the load-sensing pump 202 is determined to be equal to the pre-determined cut-out pressure of the high pressure cut-off valve 206, the controller 118 initiates the counter-timer. After initiation of the counter-timer, the controller 118 compares the counter-timer with the pre-determined time threshold. In the meanwhile, the hydraulic fluid is delivered to the charge supply valve 210 at the margin valve output pressure, via the margin valve 204. As the load-sensing pump 202 senses that the margin valve output pressure is equal to the pre-determined cut-off pressure, the hydraulic fluid is delivered to the charge supply valve 210 at the pre-determined cut-off pressure. Hence, the high pressure cut-off valve 206 now operates the load-sensing pump 202, via the cylinder 208, to deliver the fluid to the charge supply valve 210 constantly at the pre-determined cut-out pressure. The load-sensing pump 202 delivers the fluid to charge supply valve 210 at the output pressure (the pre-determined cut-out pressure), until the accumulator pressure reaches the output pressure (the pre-determined cut-out pressure). In other words, during the time when the counter-timer becomes equal to the pre-determined time threshold, the pressure of the brake charge system 130 becomes uniform. As the controller 118 determines that the counter-timer is equal to the pre-determined time threshold, the controller 118 signals for energization of the electronic solenoid 232 and the cut-out occurs, thereby stopping charge of the first accumulator 212 and the second accumulator 214. In an embodiment, the controller 118 may determine and signal a delay of units of time corresponding to the counter-timer, to the electronic solenoid 232, for the transition between the charging state and the non-charging state.

The disclosed method 300 of pressure stabilizing the brake charge system 130 uses the load-sensing pump 202, operated for the pre-determined cut-out pressure setting to control maximum brake charge circuit pressure. In the disclosed method 300, the transition between the charging state and the non-charging state is delayed until the brake charge system 130 pressure is uniform. At that time, the flow of fluid has stopped in the brake charge system 130 and the transition from charging to non-charging can be done without a step change in flow of the fluid. However, current methods commonly experience pressure spikes and instability at the end of a charge cycle, that is, at the cut-out event. Current methods face instability, which is caused by the step change in the fluid flow when transition occurs immediately between the charging state to the non-charging state. Hence, the proposed method 300 provides the benefits of electro-hydraulic control at the cut-in event with the benefits of constant charge control at the cut-out event, without creation of instability, pressure acceleration, and/or noise.

Accordingly, this disclosure includes all modifications and equivalents of the subject matter recited in the claim appended hereto as permitted by applicable law. Moreover, any combination of the described elements in all possible variations thereof is encompassed by the disclosure unless otherwise indicated herein.

One skilled in the art will realize the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claim, rather than the foregoing description, and all changes that come within the meaning and range of equivalence of the claim are therefore intended to be embraced therein.

What is claimed is:

1. A method for pressure stabilizing an electro-hydraulically controlled brake charge system, the brake charge system including a load sensing pump, a charge supply valve, a high pressure cut-off valve, an accumulator, a sensor for sensing accumulator pressure, and a controller, the method comprising:
pressurizing the accumulator with a fluid from the load sensing pump;
comparing the accumulator pressure measured by the sensor with a pre-determined cut-out pressure;
initiating a counter-timer once the accumulator pressure is equal to the pre-determined cut-out pressure;
comparing the counter-timer to a pre-determined time threshold;
activating an electronic solenoid of the charge supply valve, once the pre-determined time threshold has elapsed; and
controlling a flow of the fluid through the charge supply valve based on a signal from the electronic solenoid in the brake charge system once the pre-determined time threshold has elapsed.
